(19) United States
(12) Patent Application Publication
(10) Pub. No.: US 2007/0107476 A1
(43) Pub. Date: May 17, 2007

(54) Laminated Padlock

(75) Inventor: Jiaqiang Ruan, Kowloon (HK)

Correspondence Address: Raymond Y. Chan, 108 N. Ynez Ave., #128, Monterey Park, CA, 91754, US

(73) Assignee: Path Line (NG'S) Holdings Limited

(21) Appl. No.: 11/282,152

(22) Filed: Nov. 17, 2005

(51) Int. Cl. E05B 67/24

(52) U.S. Cl. 70/38 A

(57) ABSTRACT

A laminated padlock, having a lock body, a shackle moveably mounted to the lock body, a cylinder unit received within the lock body, the cylinder unit has cylinder core rotatably received within the lock body between a locking position and a releasing position, and an activating member synchronously coupled to said cylinder core. A latching arrangement provided for associating the cylinder unit and the shackle, which has a pair of striking chip received within the lock body with an opposite moveable manner for managing a release of the shackle, in the locking position, the activating member is capable of driving two striking chips outwardly extended to insert into the shackle legs for locking up the shackle, in the releasing position, the activating member is capable of inwardly retracting the striking chips from the shackle legs so as to disengage the shackle legs from the lock body.

### BACKGROUND OF THE PRESENT INVENTION

1. Field of Invention

The present invention relates to a kind of lock, and more particularly, relates to a kind of laminated padlock having a reinforced and improved striking mechanism for effectively managing an operation of the shackle with respect to the lock body so as to substantially prolong the life span of the laminated padlock.

2. Description of Related Arts

A lock is a mechanical fastening device which may be used everywhere since it provides people with a sense of security. It is not surprised that a variety of locks are used on doors, vehicles, containers, or any means to be opened, wherein the padlock is one of the most common locks in routine applications. Ordinarily, a padlock comprises a lock body, a shackle moveably mounted onto the lock body to form a loop retaining an object in position, and a cylinder received into the lock body for maneuvering a releasing operation of the shackle, etc.

Commonly, the lock body of the padlock is prepared by an integral metal, wherein a cylinder cavity and a pair of shackle hole are defined onto the top side of lock body for respectively receiving the lock cylinder and two shackle legs. Seemingly, such kind of padlock has a relatively simpler structure to be assembled in practice. However, since the lock body is made of an integral metal block, defining an optimal shape of such cylinder cavity or shackle holes would be time consuming and mechanically challenging. Therefore, people introduced a new type of laminated padlock for replacing conventional padlock, wherein the lock body of the laminated padlock comprises a plurality of metal plates laminated together for forming a lock body. Accordingly, each individual metal plate could be purposely shaped and through-carved with openings so as to ensure the cylinder cavity to be perfectly designed.

As shown in FIG. 1, one of the most important elements of the laminated padlock is the striking chip A, which is provided within a striking plate B. A resilient element C is positioned against one side of the striking chip A for biasing the striking chip A. Commonly, a conventional padlock is operated in such a manner, when a correct key is inserted into the lock cylinder for driving a cylinder core into rotation, an activating element coupled to the lock cylinder would be subsequently actuated thus forcing the striking chip into action. One leg of the shackle is provided with an engaging groove for receiving the extended striking chip stuck therein so as to interlock the shackle from being released.

However, the resilient element C is ordinarily embodied as a curve-shaped spring steel, wherein one end of the spring steel is biasing against a side edge of the striking chip A, while another end and the curve portion of the spring steel are respectively positioned two corners of the striking plate B. Due to the fact that the padlock would be repeatedly locked and released in operations, the strength of the spring steel must be intensified for ensuring a consistent performance after an extended service of such padlock. However, after hundreds of thousands of the operations, the fatigue grade of the spring steel would be more or less degraded thus deteriorating the life span of the padlock.

On the other hand, the spring steel is defined as an irregular curved shape, the biasing force applied onto the striking chip A would be difficult to be controlled with an evenly distributed force. Most of the time, the striking chip would not be operated with a smooth manner, thus unnecessarily increasing the friction force between the striking chip A and the inner wall of the striking plate B. It is necessary to improve the conventional laminated padlock.

### SUMMARY OF THE PRESENT INVENTION

A primary object of the present invention is to provide a laminated padlock, wherein the striking chip and striking plate structure is redesigned so as to ensure the biasing force applied onto the striking chip are evenly distributed, such at the movement between the striking chip and the striking plate would be smoothed in applications.

Another object of the present invention is to provide a laminated padlock having a pair of striking chips orientated with opposite direction for simultaneously locking two legs of the shackle in position thus ensuring the padlock more reliable in applications.

Another object of the present invention is to provide a laminated padlock having an improved striking structure for not only prolonging the life span of the padlock, but also for strengthening the anti-breaking function.

Another object of the present invention is to provide a laminated padlock having an improved striking structure, wherein the convention curved shaped steel spring will be replaced with elongated resilient members, while the reciprocal movement of the striking chip would not be affected in applications.

Another object of the present invention is to provide a laminated padlock having an improved striking structure to eliminate the likelihood of striking chips being over fractioned, stuck or snapped within the striking plates.

Another object of the present invention is to provide a laminated padlock having an improved striking structure, wherein two striking plates are separated with strengthened enhancement plate for further intensifying the overall safety of the padlock.

Another object of the present invention is to provide a laminated padlock having an improved striking structure, wherein no complicated structures or expensive elements would be required to achieve above mentioned objects.

Accordingly, to achieve above mentioned objects, the present invention provides a laminated padlock, comprising:

a lock body comprising a plurality of hollow body panels overlapped with each other to form a receiving cavity therein;

a cylinder unit comprising a cylinder barrel supported in the receiving cavity and a cylinder core, having a key slot for a corresponding key inserting thereinto, rotatably disposed within the cylinder barrel between a locked position and an unlocked position, wherein at the locked position, the cylinder core is normally locked in the cylinder barrel to lock up a rotation movement of the cylinder core, and at the unlocked position, the cylinder core is allowed to be freely rotated within the cylinder barrel when the corresponding key is slidably inserted into the key slot; and

a latching arrangement, comprising:

a shackle having a sliding end portion slidably mounted to the lock body in a longitudinal direction and a locking end portion arranged in such a manner that when the sliding end portion of the shackle is slid into the lock body, the locking end portion of the shackle is coupled with the lock body to form a closed loop;

a first latch slidably supported in said receiving cavity in a transverse direction to lock with the locking end portion of the shackle when the locking end portion of the shackle is coupled with the lock body, wherein the first latch is driven to slide inwardly when the cylinder core is rotated within the cylinder barrel to release the locking end portion of the shackle from the first latch so as to allow the shackle being pulled upwardly to form an open loop;

a second latch which is releasably lock at the sliding end portion of the shackle and is slidably supported in the receiving cavity in a transverse direction opposite to the first latch, wherein the second latch is driven to slide inwardly concurrently to the first latch when the cylinder core is rotated within the cylinder barrel to release the sliding end portion of the shackle from the second latch; and

means for applying an urging force against the first and second latch to normally push the first latch to engage with the locking end portion of the shackle.

These and other objectives, features, and advantages of the present invention will become apparent from the following detailed description, the accompanying drawings, and the appended claims.

### BRIEF DESCRIPTION OF THE DRAWINGS

FIG. 1 is a top view of a striking unit according to a prior art.

FIG. 2 is a front view of a laminated padlock according to a preferred embodiment of the present invention.

FIG. 3 is an exploded perspective view of the laminated padlock according to above preferred embodiment of the present invention.

FIG. 4A is a sectional view of the laminated padlock according to the above preferred embodiment of the present invention.

FIG. 4B is a front view of the latching arrangement according to the above preferred embodiment of the present invention.

FIG. 5A is an exploded perspective view of the latching arrangement according to the above preferred embodiment of the present invention.

FIG. 5B is a schematic view of the latching arrangement according to the above preferred embodiment of the present invention.

FIG. 6A is a perspective view of the cylinder unit of the above preferred embodiment of the present invention.

FIG. 6B is exploded perspective view of the cylinder unit of the above preferred embodiment of the present invention.

### DETAILED DESCRIPTION OF THE PREFERRED EMBODIMENT

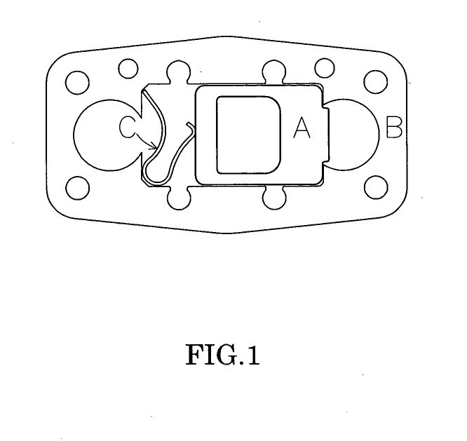

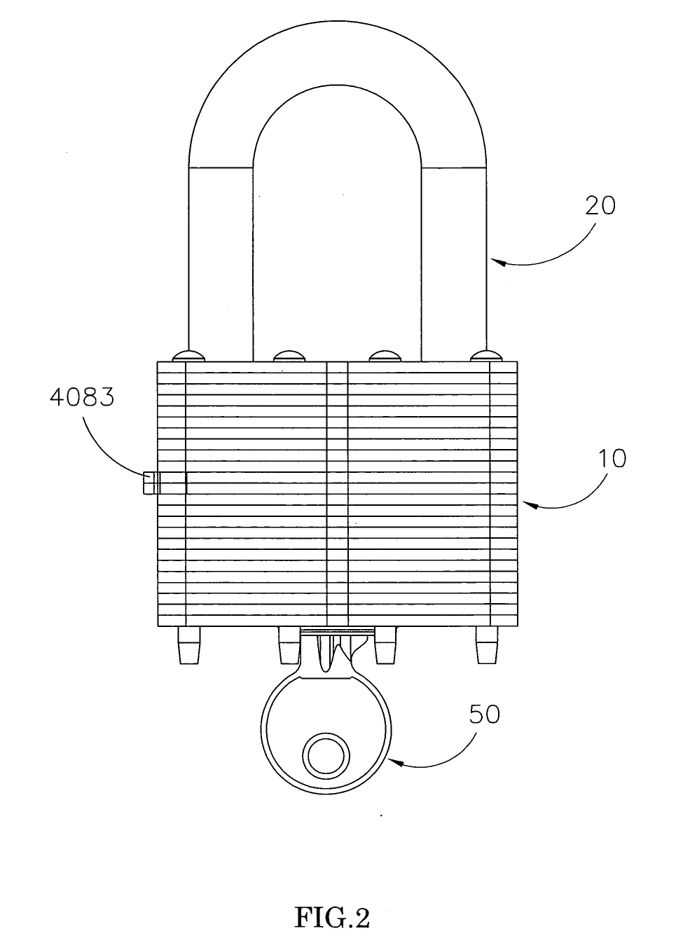

Referring to FIG. 1 to FIG. 6, a laminated padlock according to the preferred embodiment of the present invention is illustrated. The laminated padlock 1 comprises a lock body 10, which is prepared by a plurality of hollow body panels 101 overlapped with each other to form a receiving cavity 102 therein.

The laminated padlock 1 further comprises a shackle 20, having two legs, moveably mounted to the lock body 10 for defining a locking loop between the lock body 10 and the shackle 20 so as to secure an object therebetween.

The laminated padlock 1 comprises a cylinder unit 30 comprising a cylinder barrel 31 supported in the receiving cavity 102 and a cylinder core 311, having a key slot for a corresponding key inserting thereinto, rotatably disposed within the cylinder barrel 31 between a locked position and an unlocked position, wherein at the locked position, the cylinder core 311 is normally locked in the cylinder barrel 31 to lock up a rotation movement of the cylinder core 311, and at the unlocked position, the cylinder core 311 is allowed to be freely rotated within the cylinder barrel 31 when the corresponding key is slidably inserted into the key slot.

Accordingly, the laminated padlock 1 comprises a cylinder unit 30 received within the receiving cavity 102. The cylinder unit 30 comprises a cylinder barrel 31, a cylinder core 311 rotatably received within the cylinder barrel 31, wherein the cylinder core 311 has a key slot for inserting a key to rotate the cylinder core 311 with respect to the cylinder barrel 31 between a locking position and a releasing position, and an activating member 32 coupled to the cylinder core 311 to be synchronously rotated along with the cylinder core 311.

Furthermore, the laminated padlock comprises a latching arrangement 40, comprising a shackle 20 having a sliding end portion slidably mounted to the lock body 10 in a longitudinal direction and a locking end portion arranged in such a manner that when the sliding end portion of the shackle is slid into the lock body 10, the locking end portion of the shackle is coupled with the lock body to form a closed loop.

The latching arrangement 40 further comprises a first latch 401 slidably supported in the receiving cavity 102 in a transverse direction to lock with the locking end portion of the shackle 20 when the locking end portion of the shackle is coupled with the lock body 10, wherein the first latch 401 is driven to slide inwardly when the cylinder core is rotated within the cylinder barrel 31 to release the locking end portion of the shackle 20 from the first latch 401 so as to allow the shackle 20 being pulled upwardly to form an open loop.

Moreover, the latching arrangement 40 comprises a second latch 402 which is releasably lock at the sliding end portion of the shackle and is slidably supported in the receiving cavity 102 in a transverse direction opposite to the first latch 401, wherein the second latch 402 is driven to slide inwardly concurrently to the first latch 401 when the cylinder core 311 is rotated within the cylinder barrel 31 to release the sliding end portion of the shackle 20 from the second latch 402.

The latching arrangement 40 further comprises means for applying an urging force against the first and second latch 401, 402 to normally push the first latch 401 to engage with the locking end portion of the shackle.

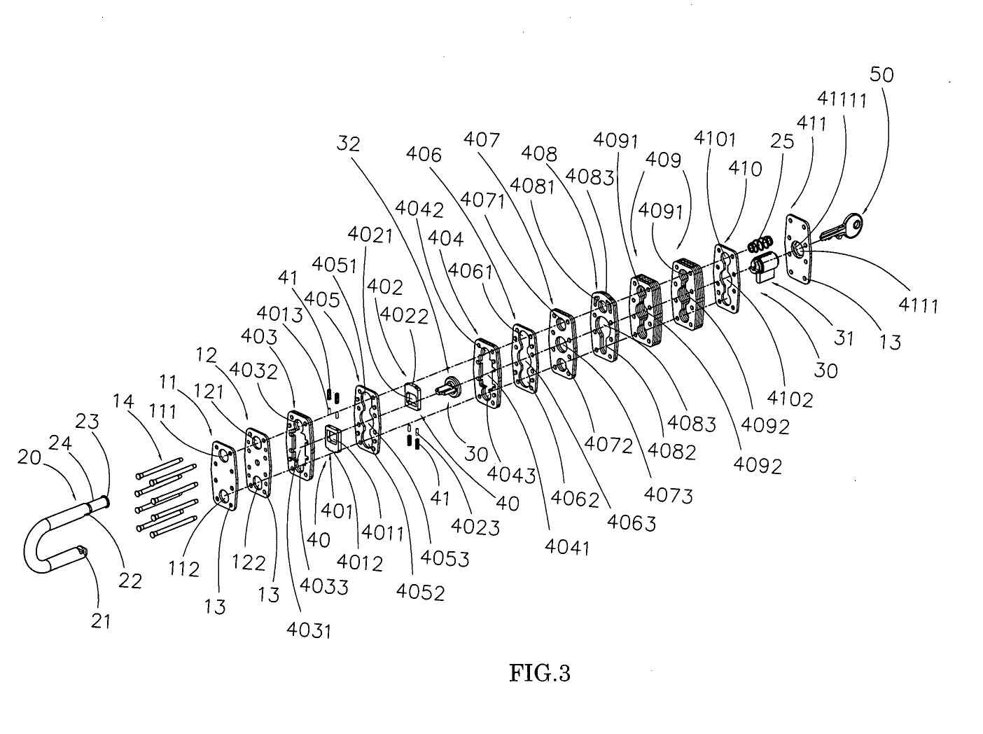

According to the preferred embodiment of the present invention, the hollow body panel 102 could be defined to have a variety of shapes, such as rectangle shape, oval shape, round shape, etc. In the preferred embodiment, the hollow body panels 102 are oval shaped. As shown in FIG. 3, the lock body 10 comprises a plurality of hollow body panels overlapped together, respectively, a top panel 11, a protection panel 12, a first latching panel 403, a first separation panel 405, a second latching panel 404, a second separation panel 406, an activating member positioning panel 407, a cylinder ridge stopper panel 408, a cylinder positioning panel 409, a cylinder end panel 410, and a bottom panel 411.

Accordingly, to ensure that the plurality of the hollow body panels 102 easily laminated together, the edges of each hollow body panel are unexceptionally provided a plurality of through holes 13 defined thereon. As a result, when such plurality of hollow body panels 102 are stacked together to form the lock body 10, the through holes 13 respectively defined on different hollow body panels are aligned together to form a plurality of longitudinal channels for receiving rivets 14 so as to reinforce the lock body 10 in applications.

As shown in FIG. 3, the top panel 11, as its name implied, is provided at an upper position and defined to have two receiving slots 111, 112 for receiving two end portions of the shackle 20. A plurality of through holes 13 is symmetrically defined onto the hollow body panels at a position close to edges for penetrating the above mentioned rivets 14. The protection panel 12 is positioned between the top panel 11 and the first latching panel 403 for preventing a burglar or intruder from damaging the latch panels by a drill or similar means. Preferably, the protection panel 12 is made of hardened carbonized steel. Accordingly, two receiving slots 121, 122 and correspondingly mated through holes 13 are defined onto the protection panel as well.

According to the preferred embodiment, the urging means comprises first and second resilient units 41 transversely and spacedly supported in the receiving cavity 102 for pushing the first and second latch panels 401, 402 towards the locking end portion and the sliding end portion of the shackle 20 respectively. Here, the first and second latches 401, 402 are two latch panels respectively and spacedly slid within the receiving cavity 102 in an opposed transverse direction. In the present invention, each of the first and second resilient units 41 comprises two compression springs spacedly and transversely urging the respective latch to evenly distribute the urging force against the respective latch.

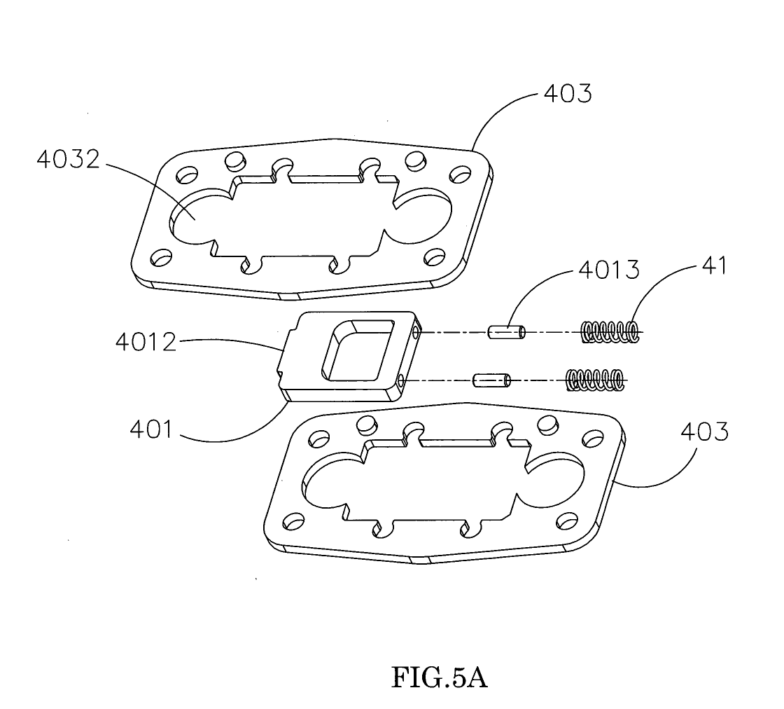

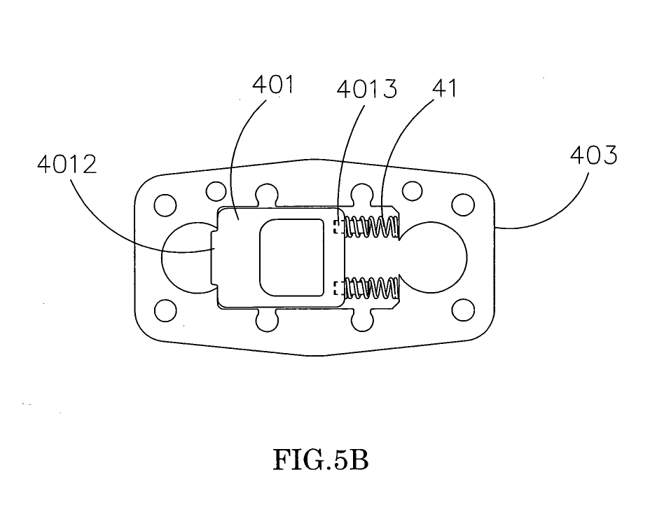

The first and second latching panels 403, 404 are correspondingly provided under the protection panel 12, wherein each of the latching panels is formed with two slim sheet laminated together as shown in FIG. 5A. It is noted that two latching panels 403, 404 are separated by the first separation panel 405. Each of the latching plate 403, 404 is frame shaped to define a latching cavity, namely a first latching cavity 4031 and a second latching cavity 4041 therein, for respectively and correspondingly receiving the first latch panel and the second latch panel 402 in position. Understandably, the length of the latching cavity is longer than the length of the latch panel for permitting the latch panel longitudinally shifted within the latching cavity. It is worth to mention that two ends of the first latching cavity 4031 and the second latching cavity 4041 are purposely shaped for allowing the two end portions of the shackle 20 penetrating through. Furthermore, the first separation plate 405 is frame shaped longitudinally defining three continuous through holes, namely shackle through slots 4051, 4052 for penetrating two end portions of the shackle 20, and activating member slot 4053 for receiving the activating member 32.

As shown in FIG. 3 and FIG. 5, the latching arrangement 40 is received in the first and second latching panel 403, 404, wherein the latching arrangement 40 comprises the first latch 401, a second latch 402 and at least two resilient units 41 biasing one end of the latch 401, 402. Accordingly, the latches 401, 402 are correspondingly shaped to match the first and second latching cavity 4031, 4041. Each of the latches has a through opening 4011, 4021 for respectively inserting into the activating member 32 of the cylinder unit 30. It is noted that two outside ends of the latches, i.e. the ends engaged with the shackle end portions, are defined as free ends of the latches. On the other hand, there are two engaging slots 21, 22 respectively provided at two end portions of the shackle 20 for correspondingly receiving the inserting free ends of the latches while the cylinder core 311 is shifted into the locking position. And another end of the latches, which is opposite to the free end of such free end of the latches, is defined as supporting end.

Moreover, the urging means further comprises two at least a pair of holding pins 4013, 4023 spacedly extended from each of the first and second latches 401, 402 to substantially hold the two corresponding compression springs in position, so as to ensure the compression springs urging the first and second latches 401, 402. Preferably, the pair of the holding pins 4013, 4023 are sidewardly and integrally projected from the supporting end of latch, wherein the resilient unit 41 is sleeved onto the holding pins for retaining the striking chip within the striking cavity in position. To ensure the resilient unit 41 apply an evenly distributed biasing force, two supporting pin are symmetrically and spacedly provided at the support edge of the striking chip. It is worth to mention that the resilient unit 41, i.e. compression spring, is made of high intensity materials, preferably, phosphoretic steel. That is to say, each of the resilient unit 41 has a supporting end sleeved onto the holding pin while another end biasing against the side wall of the latching cavity. By adjusting the strength of the resilient unit 41, a user is able to control the latching effect of the latch with a balanced manner.

That is to say, when the cylinder core 311 is shifted into the locking position, the two latches are outwardly extended to snap onto the two end portions of the shackle 20. When the cylinder core 311 is shifted into the releasing position, two latch panels respectively received within two striking plates are activated to approach with each other thus disengaging from the shackle.

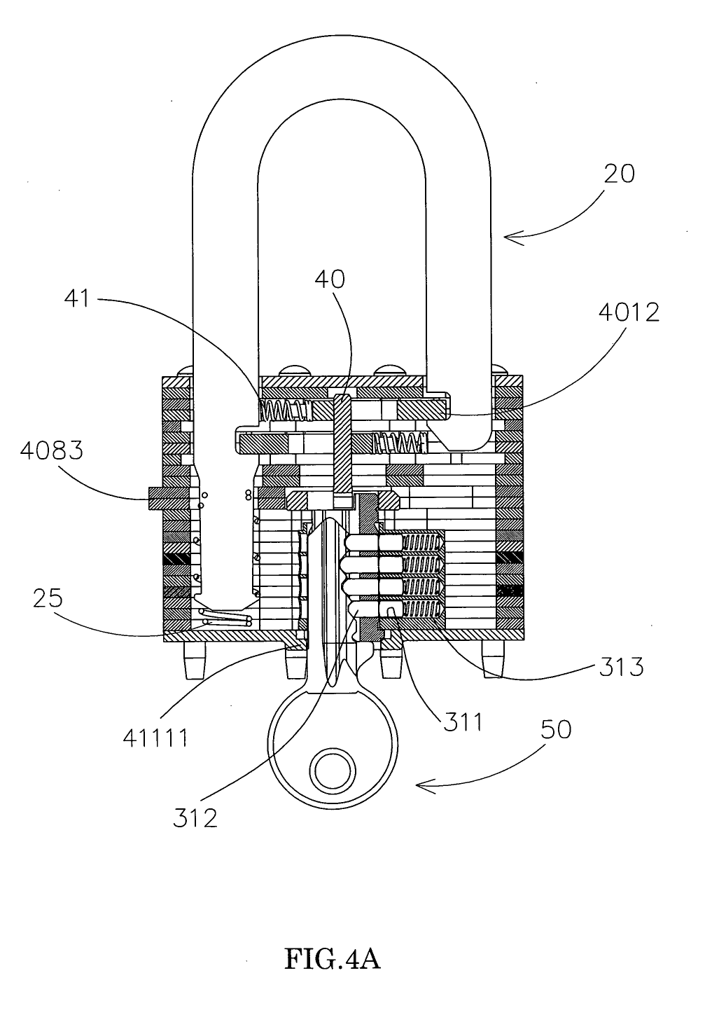

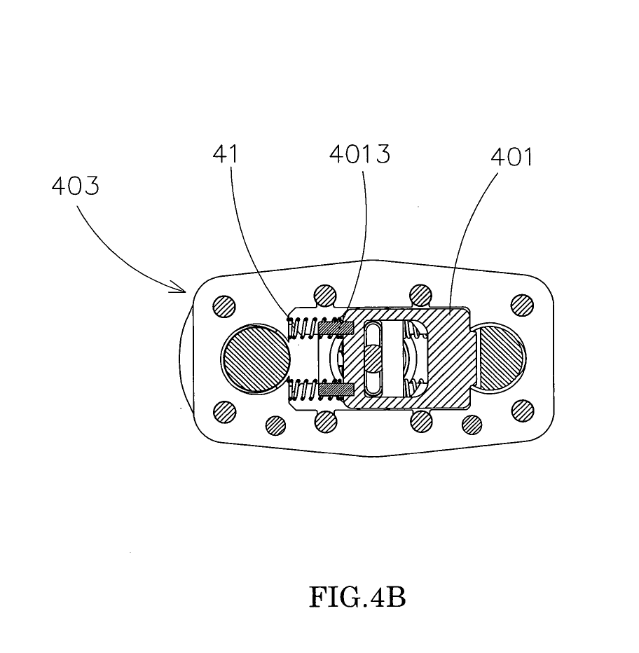

As shown in FIG. 4A, the first latch 401 and the second latch 402 are oppositely orientated, wherein each of the free end of the latches are outwardly orientated towards the end portions of the shackle 20. The first latch 401 is disposed at the right side of the first latching panel 403, while the second latching panel 402 is disposed at the left side of the second latching panel. As a result, when the cylinder core 311 is shifted to the locking position, the first and second latches are oppositely extended to insert into the shackle slot 21, 22 in position.

Furthermore, the latching arrangement 40 comprises a latch spacer 405 disposed within the receiving cavity 102 at a position between the first and second latches 401, 402 so as to create a moving space within the receiving cavity to allow the first and second latches 401, 402 transversely sliding therewith in an opposed direction.

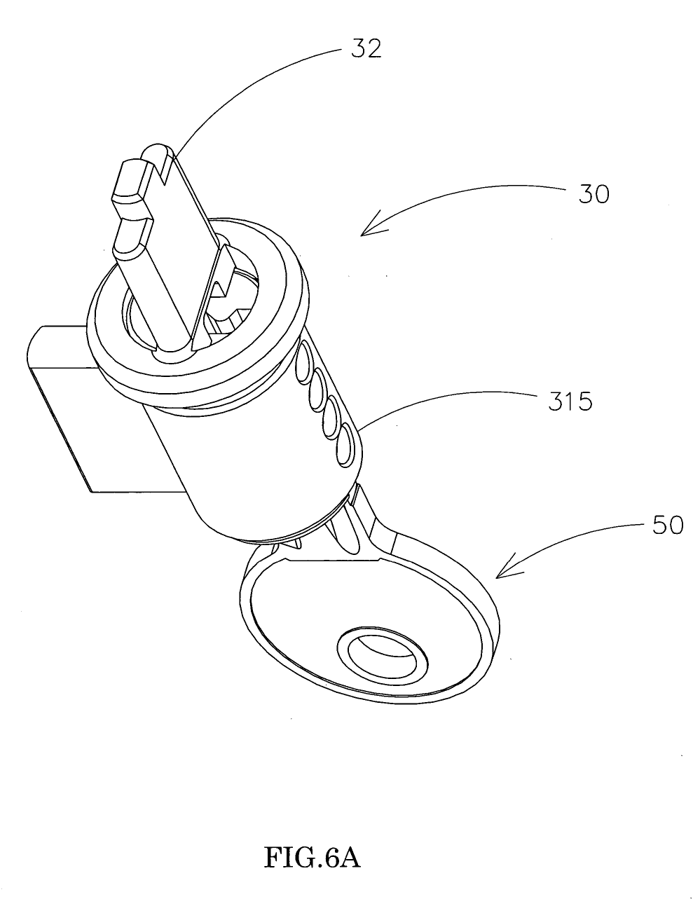

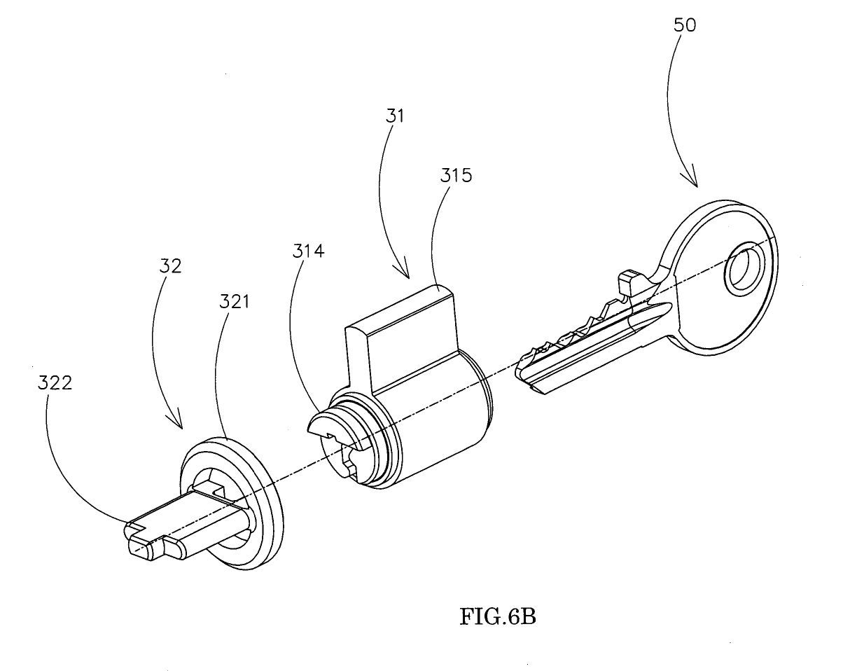

As shown in FIG. 6, the cylinder unit 30 comprises a cylinder barrel 31 and an driving member 32 coupling between the cylinder core 311 and the latching arrangement 40, wherein the cylinder 30 is a conventional lock cylinder, and the driving member 32 is arranged in such a manner that when the cylinder core 311 is driven to rotate, the driving member 32 is capable of concurrently pulling the first and second latches 401, 402 to disengage with the locking end portion and the sliding end portion of the shackle respectively. Accordingly, there is a pin tumbler assembly 312 and a plurality of springs 313 provided within cylinder barrel 31 for associating the key-insertion-rotation function as conventional pin-tumbler lock.

Moreover, the driving member 32 comprises a supporting disc 321 coupled to the cylinder core 311 and an activating inserter 322 for driving the latches into action. The cylinder barrel 31 is positioned with the cylinder positioning panel 409, cylinder end panel 410 and the bottom panel as shown in FIG. 3. It is noted that the cylinder positioning panel 409 further comprises an upper positioning plate and a lower positioning plate, each of which comprises a plurality of slim plates laminated together. And both the cylinder positioning panel and cylinder end panel have through slots defined thereon for insertion of the shackle end portions.

What is more, there is a cylinder cavity continuously defined at the cylinder positioning panel 409, cylinder end panel 410 and the bottom panel 411 for accommodating the cylinder barrel 31. That is to say, each of the cylinder positioning panel 409, cylinder end panel 410 and the bottom panel 411 has a cylinder through opening 4092, 4102, and 4111 defined to be aligned together to form a cylinder accommodating channel. Furthermore, a reinforcement edge 41111 is provided circling around the cylinder through opening 4111 of the bottom plate 411, wherein the reinforcement edge 41111 has a diameter greater than the diameter of the cylinder through opening 4111 so as to longitudinally retain the cylinder in position.

The supporting disc 321 is disposed within the cylinder ridge stopper plate 408, and is coupled to the rotatable cylinder core 311. The flat inserter 322 is adapted to penetrate the activating member positioning panel 407, the second separation panel 406, the second latching 404, the first separation panel 405, the first latch 401, and the second latch 402 as shown in FIG. 4A.

It is noted that the two side edges of the flat inserter 322 are respectively biasing against the inner wall of the through opening 4011, 4012. When the cylinder core 311 is shifted into the releasing position, the flat inserter 322 would be rotated thus forcing two latches 401, 402 approached with each other so as to release the shackle end portions from the lock body. It is worth to mention that the one end portion is supported by a retaining spring 25 received within the lock body 10, such that when the latches are disengaged from the shackle slot 21, 22, the retaining spring 25 is capable of facilitating the shackle 20 spring out from the lock body 10.

In other words, the shackle 20 is embodied as a U shaped body having two shackle legs, namely a primary leg having a longer size moveably penetrated through the plurality of shackle slots defined onto the plurality of panels. Accordingly, each of the shackle legs has a locking slot defined thereon for correspondingly mating with the free ends of the latches. Moreover, to ensure the shackle 20 still in loose connection with the lock body 10 when the cylinder core 311 is shifted into the releasing position, the primary leg of the shackle 20 further comprises a retaining shoulder 23 defined thereon. The shackle slot 4081 of the shackle plate has a relatively smaller diameter in comparison with the diameter of the retaining shoulder 23 for preventing the released shackle from jumping out from the lock body.

Each of the first and second latching panels 403, 404 comprises two identical metal sheets as shown in FIG. 5A. And the first separation panel 405 is positioned between two latching panels.

As shown in FIG. 3 and FIG. 5A, each of the first latching panel 403 and the second latching panel 405 has a striking frame which is correspondingly mated with the latches 401 and 402. The striking frame 4031, 4041 are rectangular shaped and each of which has a length and a width respectively covering the length of the latch. As a result, the latch is capable of being longitudinally shifted within the striking frame of the latching panel. Moreover, the shackle slots are defined penetrating the latching panel at two ends of the latching panel. And the first separation panel 405 has a continuous elongated through slot for simultaneously accommodating the two end portions of the shackle and the driving member 32.

Referring to FIG. 3 and FIG. 5, the latching arrangement 40 is received within the latching panel 403 and 404. The first latch 401 and the second latch 402 are snugly received within the striking frames provided in the latching panel. Each of the latches has a through carved opening defined thereon for inserting the driving member 32 of the lock cylinder unit 30.

Another end of the latch is defined as a free end positioned close to the two end portions of the shackle 20. The free end is embodied as inserting end to be inserted into the shackle slot 21, 22 so as to lock up the shackle 20 in the locking position. Another end of the latch is retaining end retained by biasing means. In the preferred embodiment of the present invention, two retaining members are outwardly and integrally projected from the latch. Or otherwise, the retaining members are mounted into the coupling cavities provided at the latches.

As shown in FIG. 4A, the two latches 401, 402 are received within the latching panel for biasing the frame wall towards the shackle. It is noted that the biasing force of the latches could be purposely adjusted by altering the resilient unit strength. In the locking position, the first latch 401 and the second latch are opposedly biased to inserted into the shackle slots 21, 22 defined at two end portions of the shackle 20 for preventing the shackle 20 from being released from the lock body 10.

That is to say, the first latch 401 and the second latch 402 are orientated with opposite direction, wherein the inserting end of the latch is orientated towards the shackle 20. The first latch 401 is received within the first latching panel at a position close to the right side of the lock body 10, and the second latch 402 is received within the second latching panel at a position close to the left side of the lock body.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A padlock, comprising:
a lock body comprising a plurality of hollow body panels overlapped with each other to form a receiving cavity therein;
a cylinder unit comprising a cylinder barrel supported in said receiving cavity and a cylinder core, having a key slot for a corresponding key inserting thereinto, rotatably disposed within said cylinder barrel between a locked position and an unlocked position, wherein at said locked position, said cylinder core is normally locked in said cylinder barrel to lock up a rotation movement of said cylinder core, and at said unlocked position, said cylinder core is allowed to be freely rotated within said cylinder barrel when said corresponding key is slidably inserted into said key slot; and
a latching arrangement, comprising:
a shackle having a sliding end portion slidably mounted to said lock body in a longitudinal direction and a locking end portion arranged in such a manner that when said sliding end portion of said shackle is slid into said lock body, said locking end portion of said shackle is coupled with said lock body to form a closed loop;
a first latch slidably supported in said receiving cavity in a transverse direction to lock with said locking end portion of said shackle when said locking end portion of said shackle is coupled with said lock body, wherein said first latch is driven to slide inwardly when said cylinder core is rotated within said cylinder barrel to release said locking end portion of said shackle from said first latch so as to allow said shackle being pulled upwardly to form an open loop;
a second latch which is releasably lock at said sliding end portion of said shackle and is slidably supported in said receiving cavity in a transverse direction opposite to said first latch, wherein said second latch is driven to slide inwardly concurrently to said first latch when said cylinder core is rotated within said cylinder barrel to release said sliding end portion of said shackle from said second latch; and
means for applying an urging force against said first and second latch to normally push said first latch to engage with said locking end portion of said shackle.

2. The padlock, as recited in claim 1, wherein said urging means comprises first and second resilient units transversely and spacedly supported in said receiving cavity for pushing said first and second latches towards said locking end portion and said sliding end portion of said shackle respectively.

3. The padlock, as recited in claim 1, wherein said first and second latches which are two latch panels respectively and are spacedly slid within said receiving cavity in an opposed transverse direction.

4. The padlock, as recited in claim 2, wherein said first and second latches which are two latch panels respectively and are spacedly slid within said receiving cavity in an opposed transverse direction.

5. The padlock, as recited in claim 3, wherein each of said first and second resilient units comprises two compression springs spacedly and transversely urging said respective latch to evenly distribute said urging force against said respective latch.

6. The padlock, as recited in claim 4, wherein each of said first and second resilient units comprises two compression springs spacedly and transversely urging said respective latch to evenly distribute said urging force against said respective latch.

7. The padlock, as recited in claim 5, wherein urging means further comprises two holding pins spacedly extended from each of said first and second latches to substantially hold said two corresponding compression springs in position, so as to ensure said compression springs urging said first and second latches.

8. The padlock, as recited in claim 6, wherein urging means further comprises two holding pins spacedly extended from each of said first and second latches to substantially hold said two corresponding compression springs in position, so as to ensure said compression springs urging said first and second latches.

9. The padlock, as recited in claim 1, wherein said latching arrangement further comprises a latch spacer disposed within said receiving cavity at a position between said first and second latches so as to create a moving space within said receiving cavity to allow said first and second latches transversely sliding therewith in an opposed direction.

10. The padlock, as recited in claim 4, wherein said latching arrangement further comprises a latch spacer disposed within said receiving cavity at a position between said first and second latches so as to create a moving space within said receiving cavity to allow said first and second latches transversely sliding therewith in an opposed direction.

11. The padlock, as recited in claim 8, wherein said latching arrangement further comprises a latch spacer disposed within said receiving cavity at a position between said first and second latches so as to create a moving space within said receiving cavity to allow said first and second latches transversely sliding therewith in an opposed direction.

12. The padlock, as recited in claim 9, wherein at least one of said body panels used as said latch spacer to separate said first and second latches within said receiving cavity.

13. The padlock, as recited in claim 10, wherein at least one of said body panels used as said latch spacer to separate said first and second latches within said receiving cavity.

14. The padlock, as recited in claim 11, wherein at least one of said body panels used as said latch spacer to separate said first and second latches within said receiving cavity.

15. The padlock, as recited in claim 1, wherein said first latch is parallelly positioned higher than said second latch.

16. The padlock, as recited in claim 8, wherein said first latch is parallelly positioned higher than said second latch.

17. The padlock, as recited in claim 14, wherein said first latch is parallelly positioned higher than said second latch.

18. The padlock, as recited in claim 1, further comprising a driving member coupling between said cylinder core and said latching arrangement, wherein said driving member is arranged in such a manner that when said cylinder core is driven to rotate, said driving member concurrently pulls said first and second latches to disengage with said locking end portion and said sliding end portion of said shackle respectively.

19. The padlock, as recited in claim 8, further comprising a driving member coupling between said cylinder core and said latching arrangement, wherein said driving member is arranged in such a manner that when said cylinder core is driven to rotate, said driving member concurrently pulls said first and second latches to disengage with said locking end portion and said sliding end portion of said shackle respectively.

20. The padlock, as recited in claim 17, further comprising a driving member coupling between said cylinder core and said latching arrangement, wherein said driving member is arranged in such a manner that when said cylinder core is driven to rotate, said driving member concurrently pulls said first and second latches to disengage with said locking end portion and said sliding end portion of said shackle respectively.
